(19) United States
(12) Patent Application Publication
(10) Pub. No.: US 2016/0297109 A1
(43) Pub. Date: Oct. 13, 2016

(54) RADIANT CURING SYSTEM AND METHOD FOR COMPOSITE MATERIALS

(71) Applicant: BOMBARDIER INC.., Dorval (CA)

(72) Inventors: Paul TRUDEAU, St-Bruno (CA); Mouhcine RIFAY, Montreal (CA); Hasan SALEK, Laval (CA)

(21) Appl. No.: 15/035,892

(22) PCT Filed: Nov. 12, 2014
(86) PCT No.: PCT/IB2014/065998

§ 371 Date: May 11, 2016

Related U.S. Application Data
(60) Provisional application No. 61/903,153, filed on Nov. 12, 2013.

(51) Int. Cl. B29C 35/02; B29C 70/54; B29C 35/08; B29C 70/44

(52) U.S. Cl. CPC B29C 35/0288; B29C 70/443; B29C 70/54; B29C 35/0805; B29C 2035/0822

(57) ABSTRACT

A device (10, 110, 210, 310, 410, 510, 610) for curing a composite material, including a heating unit support (12, 112, 212, 312, 412, 512, 612a, 612b, 612c) supporting a plurality of heating units (16) each having a radiant heat source directed toward a corresponding portion of a heating volume (V) with at least some of the heating units (16) being controllable independently of one another. The heating volume (V) is formed by the combination of radiations emitted by the heating units (16) when the heating units are powered. A mold support (14, 114, 314, 414, 514, 614) is configured to retain a mold (11311, 411, 511) containing the composite material to be cured such that the mold is separated from the heating units (16) by a planar section (S) of the heating volume (V). A method and a control system for curing first component made of composite material using radiant energy are also disclosed.

### CROSS-REFERENCE TO RELATED APPLICATIONS

This application claims priority from U.S. provisional application No. 61/903,153 filed Nov. 12, 2013, the entire contents of which are incorporated by reference herein.

### FIELD OF THE APPLICATION

The present application relates to the curing of composites, more particularly to such curing performed through radiant heating.

### BACKGROUND OF THE ART

In radiant heating, the majority of the heat is transferred from an emitting heat source to a surface to be heated through radiation. The radiant energy is typically propagated by means of electromagnetic waves within the infrared wavelength of electromagnetic spectrum, and as such radiant heating is also referred to as infrared heating.

U.S. Pat. No. 7,824,165 to Davie et al. shows a system for curing resin in a composite structure including a plurality of heating units which are selectively positionable about a mold to provide for radiant heating of the composite structure. The heating units are preferably movably mounted on a housing to allow for mechanical or manual manipulation or positioning, so as to most accurately conform to a particular mold and provide for efficient heating thereof. The precise placement of the heating units must be determined for each mold configuration, for example through computer simulation of the curing process. Accordingly, the use of such a system for the curing of various components having different overall shapes and/or configurations, for example multiple structural elements of an aircraft, may become time consuming and/or costly.

### SUMMARY OF THE APPLICATION

It is therefore an aim of the present disclosure to provide an improved radiant curing system and method for composite materials.

In one aspect, there is provided a device for curing a composite material, the device comprising: a heating unit support supporting a plurality of heating units each having a radiant heat source directed toward a corresponding portion of a heating volume, at least some of the heating units being controllable independently of one another, the heating volume being formed by the combination of radiations emitted by the heating units when the heating units are powered; and a mold support configured to retain a mold containing the composite material to be cured, the mold being separated from the heating units at least by a planar section of the heating volume when the mold is retained by the mold support.

In a particular embodiment, all the heating units are controllable independently of one another.

In a particular embodiment, the mold support includes at least one support member spaced apart from the heating units and configured to retain the mold, each support member being located in the heating volume and being separated from the heating units by the planar section of the heating volume.

In a particular embodiment, the planar section of the heating volume extends across a surface equal to a surface of the mold exposed to the heating volume. The surface of the mold may be non-planar.

In a particular embodiment, the planar section of the heating volume extends beyond the mold.

In a particular embodiment, the device further comprises a controller connected to the heating units to control a power supply to each of the heating units to form a continuous distribution of the radiations on at least part of the mold.

In a particular embodiment, the device further comprises at least one temperature sensor for collecting data indicative of a temperature of the composite material. The controller may be connected to the at least one temperature sensor to control the power supply to the heating units based on data from the at least one temperature sensor.

In a particular embodiment, the device further comprises a plurality of cooling systems supported by the heating unit support and oriented toward the heating volume such as to direct a flow of air in the heating volume when powered. The controller may be connected to the cooling systems to control a power supply thereto based on the data from the at least one temperature sensor.

The at least one temperature sensor may include a thermal imaging camera.

In a particular embodiment, the mold support is slidingly engaged to the heating unit support. The heating unit support may include a rail and the mold support may include a member complementary to the rail and engaged therewith to guide a motion of the mold support with respect to the heating unit support.

In a particular embodiment, the heating units are positioned in a same plane. The same plane may extend horizontally, the mold being vertically spaced apart from the heating units.

In a particular embodiment, the heating units are positioned such that some of the corresponding portions of the heating volume overlap. The corresponding portions of the heating volume may overlap proximate the mold.

In a particular embodiment, each of the heating units is a lamp, the radiant heat source extending longitudinally and configured to emit radiation having a wavelength at least within the infrared range.

In a particular embodiment, the mold support is removably engaged to the heating support, and the system further comprises a second mold support configured to retain a second mold different from the first mold. The system is selectively configurable between a first configuration where the first mold support is engaged to the heating support, and a second configuration where the first mold support is removed and the second mold support is engaged to the heating support and located in the heating volume spaced apart from the heating units. The configuration and orientation of the heating units remains constant between the first and second configurations.

In a particular embodiment, the device further comprises a layer of insulating material enclosing the heating units and the heating volume together.

In a particular embodiment, the device further comprises a second plurality heating units each having a radiant heat source directed toward a corresponding portion of the heating volume. At least some of the second heating units are controllable independently of one another. The first and second plurality of heating units are spaced apart from one another with the heating volume being defined therebetween. The mold is separated from the second plurality of heating units at least by a second planar section of the heating volume when the mold is retained by the mold support.

In another aspect, there is provided a method of curing a first component made of composite material using radiant energy, the method comprising: heating a first mold supporting the first component with radiant energy emitted by heating units as a second component is being cured, the first component and mold being located in a heating volume divided into a plurality of zones each associated with at least one of the heating units; receiving second component temperature data indicative of a temperature of the second component; computing a target temperature from the second component temperature data; and for at least one of the zones occupied by the first mold: receiving first component temperature data from at least one point indicative of a temperature of the first component in the zone, computing a temperature in the zone from the first component temperature data associated therewith, comparing the temperature of the zone with the target temperature computed from the second component temperature data, and adjusting the at least one of the heating units associated with the zone when the temperature thereof is outside of a predetermined range around the target temperature computed from the second component temperature data.

In a particular embodiment, the method is performed for each one of the zones occupied by the first mold.

In a particular embodiment, the predetermined range is ±0, such that the at least one of the heating units associated with the zone is adjusted every time the temperature thereof differs from the target temperature.

In a particular embodiment, the method further comprises adjusting a cooling system producing a cooling air flow on the zone when the temperature of the zone is outside of the predetermined range.

In a particular embodiment, the first component temperature data is received from a respective one of a plurality of temperature sensors engaged to the first mold or the first component.

In a particular embodiment, the method further comprises: heating a second mold supporting the second component with the radiant energy emitted by the heating units, the second component and mold being located in the heating volume; obtaining a second target temperature from a predetermined heating profile; and for at least one of the zones occupied by the second mold: receiving the second component temperature data from at least one point indicative of a temperature of the second component in the zone, computing a temperature in the zone from the second component temperature data associated therewith, comparing the temperature of the zone with the second target temperature, and adjusting the at least one of the heating units associated with the zone when the temperature thereof is outside of a predetermined range around the second target temperature.

In a particular embodiment, the method is performed for each one of the zones occupied by the second mold.

In a particular embodiment, the predetermined range around the second target temperature is ±0, such that the at least one of the heating units associated with the zone occupied by the second mold is adjusted every time the temperature thereof differs from the second target temperature.

In another aspect, there is provided a control system for controlling curing of a first component supported by a first mold and located in a heating volume divided into a plurality of zones each associated with at least one radiant heating unit, the first component being cured through radiant heating of the first mold with the at least one radiant heating unit associated with at least one of the zones occupied by the first mold, the system comprising: a zone temperature module configured to, for the at least one of the zones occupied by the first mold, receive first component temperature data from at least one point indicative of a temperature of the first component in the zone, and compute a temperature in the zone from the first component temperature data; a target module configured to receive second component temperature data indicative of a temperature of the second component as the second component is being cured and to compute a target temperature from the second component temperature data; a comparator module configured to receive and compare the temperature in the at least one of the zones occupied by the first mold with a predetermined range around the target temperature computed from the second component temperature data, and send a comparison signal indicating a result of the comparison; and an actuation module configured to receive the comparison signal and adjust the at least one heating unit associated with the at least one of the zones occupied by the first mold and having the temperature thereof outside of the predetermined range.

In a particular embodiment, the predetermined range around the target temperature is ±0, the comparator module is configured to compare the temperature in the at least one of the zones occupied by the first mold directly with the target temperature, and the actuation module is configured to adjust the at least one heating unit associated with the at least one of the zones occupied by the first mold and having the temperature thereof different from the target temperature.

In a particular embodiment, the actuation module is also configured to adjust a corresponding cooling system oriented to produce a cooling air flow on the at least one of the zones occupied by the first mold and having the temperature thereof outside of the predetermined range.

In a particular embodiment, the second component is supported by a second mold and is located in the heating volume, the second component being cured through radiant heating of the second mold with the at least one radiant heating unit associated with at least one of the zones occupied by the second mold, and: the zone temperature module is also configured to, for the at least one of the zones occupied by the second mold, receive the second component temperature data from at least one point indicative of a temperature of the second component in the zone, and compute a temperature in the zone from the second component temperature data; the comparator module is also configured to receive and compare the temperature in the at least one of the zones occupied by the second mold with a predetermined range around a second target temperature from a predetermined heating profile, and send a second comparison signal indicating a result of the comparison; and the actuation module is also configured to receive the second comparison signal and adjust the at least one heating unit associated with the at least one of the zones occupied by the second mold and having the temperature thereof outside of the predetermined range therefor.

In a particular embodiment, the predetermined range around the second target temperature is ±0, the comparator module is configured to compare the temperature in the at least one of the zones occupied by the second mold directly with the second target temperature, and the actuation module is configured to adjust the at least one heating unit associated with the at least one of the zones occupied by the second mold and having the temperature thereof different from the second target temperature.

In a further aspect, there is provided a device for curing a composite material, the device comprising: a heating unit support supporting a plurality of individually controllable radiant heating units each having a radiant heat source directed toward a corresponding portion of a heating volume extending away therefrom, the heating units when powered emitting radiation circulating through the heating volume; and a mold support including at least one support member spaced apart from the heating units and configured to retain a mold containing the composite material to be cured, each support member being located in the heating volume and being separated from the heating units at least by a same planar section of the heating volume.

### BRIEF DESCRIPTION OF DRAWINGS

For a better understanding of the present invention, as well as other aspects and further features thereof, reference is made to the following description which is to be used in conjunction with the accompanying drawings, where:

FIG. 1a is a schematic, tridimensional view of a device for curing composite material in accordance with a particular embodiment;

FIG. 1b is a schematic, cross-sectional view of the device of FIG. 1;

FIG. 2 is a schematic, tridimensional view of a heating unit support of the device of FIG. 1;

FIG. 3 is a schematic, tridimensional view of a mold support of the device of FIG. 1;

FIG. 4 is a schematic, tridimensional view of a device in accordance with another particular embodiment;

FIG. 5 is a schematic, tridimensional view of a device in accordance with another particular embodiment;

FIGS. 6-7 are schematic, tridimensional views of devices for curing composite material during resin transfer molding, in accordance with other particular embodiments;

FIG. 8 is a schematic, tridimensional view of a device for forming and curing a fiber preform in accordance with another particular embodiment;

FIG. 9 is a schematic, tridimensional view of a device in accordance with another particular embodiment;

FIG. 10 is a flow chart of a method of curing a composite material in accordance with a particular embodiment, which may be used with the devices of FIGS. 1-9;

FIG. 11 is a flow chart of a step of determining a zone target in the method of FIG. 10, in accordance with a particular embodiment;

FIG. 12 is a flow chart of a step of detecting a vacuum leak in the method of FIG. 10, in accordance with a particular embodiment;

FIG. 13 is a block diagram of a system for curing a composite material in accordance with a particular embodiment, which may be used with the devices of FIGS. 1-9;

FIG. 14 is a block diagram of a controller or control system of the system of FIG. 13, in accordance with a particular embodiment; and

FIG. 15 is a block diagram of the comparator module of the control system of FIG. 14, in accordance with a particular embodiment.

In the drawings, embodiments of the invention are illustrated by way of example. It is to be expressly understood that the description and drawings are only for purposes of illustration and as an aid to understanding. They are not intended to be a definition of the limits of the invention.

### DESCRIPTION OF PREFERRED EMBODIMENTS

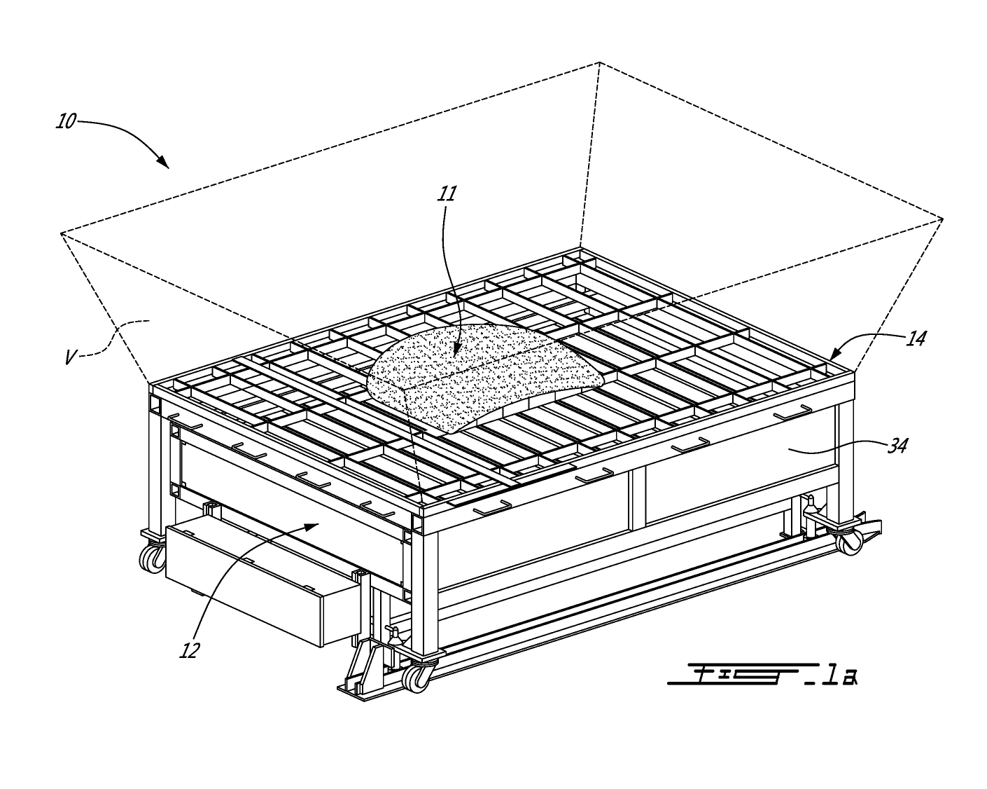

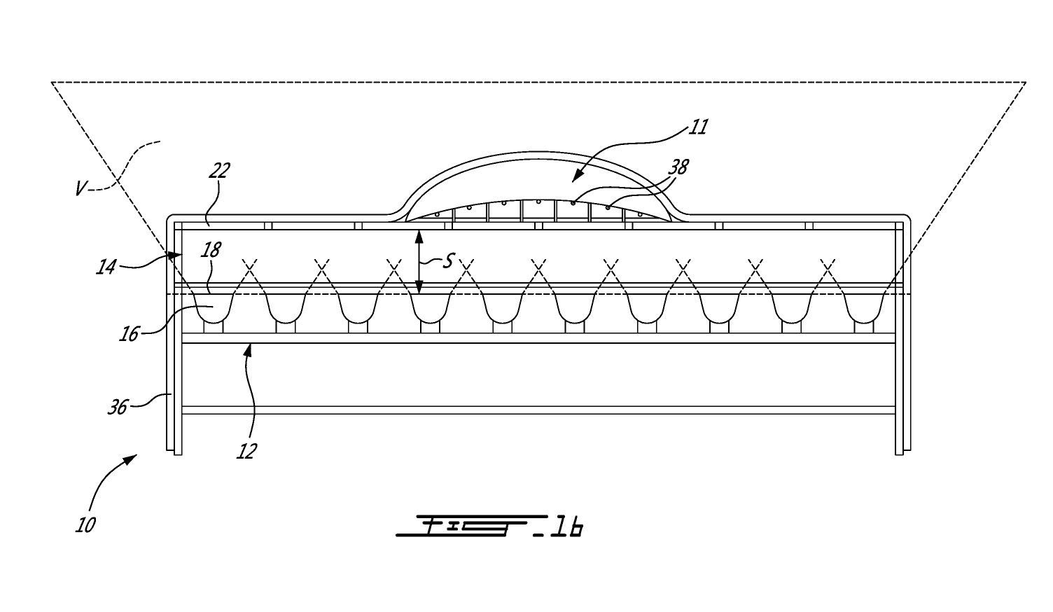

Referring to FIG. 1, a device 10 for curing a component made of composite material is generally shown. It the present application, the term “curing” is intended to include partial cures as well as complete cures, e.g. the heating of composite elements to a partial cure state such as to be able to hold a predetermined form and to a final state corresponding to that of the component in use.

The device 10 performs the cure of the component through radiant heating of the mold supporting it. In radiant heating, the heat is transferred by electromagnetic waves, without the need to heat the surrounding air. The radiant energy is absorbed by the mold, and transferred to the composite material through the mold by conduction. When compared to heating in a convective oven, where the ambient temperature is controlled by forced air convection and the mold and component are heated by the air through the boundary film that clings to the surface of the mold and/or component, radiant heating generally allows for more efficient and accurate control of the temperature of the component being heated.

The device 10 generally includes a heating unit support 12 and a mold support 14, which in the embodiment shown and removably engageable to one another.

Referring to FIGS. 1a-b and 2, the heating unit support 12 supports a plurality of radiant heating units 16, each having a radiant heat source. At least some, and preferably all, of the heating units 16 are controllable independently of one another, i.e. the level of heat produced by the heating units 16 may be adjusted individually. In a particular embodiment, each heating unit 16 is a longitudinally extending lamp emitting radiation having a wavelength at least within the infrared range. In a particular embodiment, the lamps are 240V quartz lamps having a wattage of 1 KW or 1.6 KW such as those manufactured by Chromalox®. Other types of radiant heating units 16 may alternately be used.

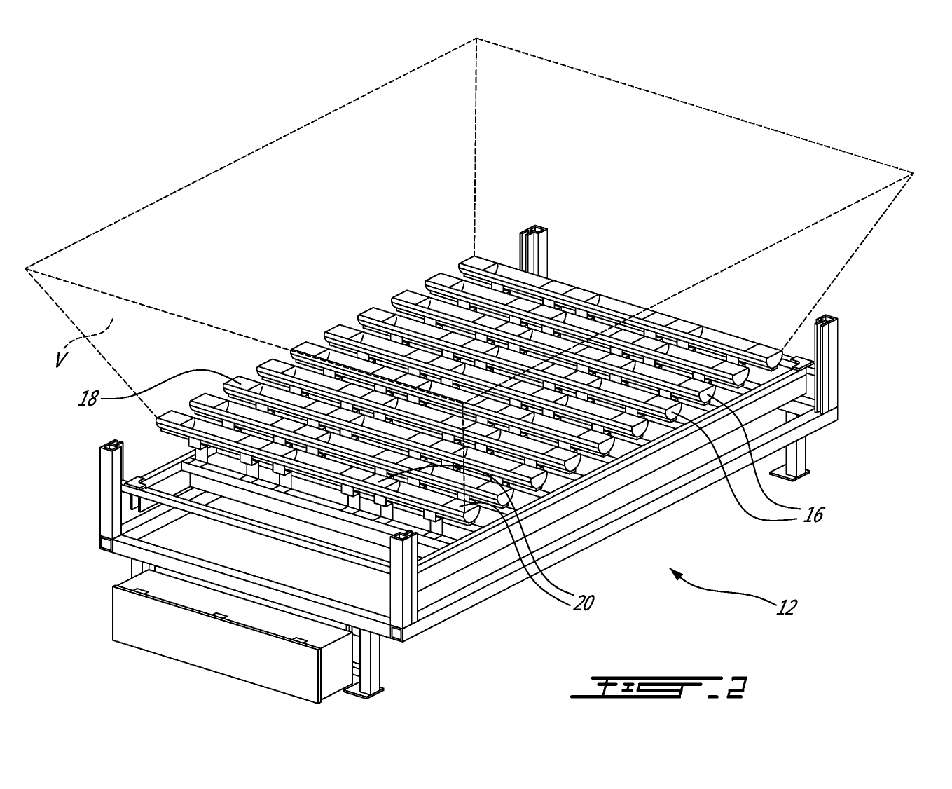

The heating units 16 together defines a heating volume V (see FIG. 2), which in a particular embodiment has a V-shape or substantial V-shape, extending away from their front face 18, i.e. from the face from which the radiant heat source emits; the heating volume V corresponds to the volume of space in which an element may be heated by the radiation of the heating units 16. In other words, the heating volume V is formed by the combination of the radiations emitted by the heating units 16 when they are powered. In the embodiment shown, the heating units 16 are oriented upwardly, and as such the heating volume V extends upwardly from their front face 18.

Radiant heaters usually have areas across their surfaces or at the edges where the energy output drops below the normal average energy uniformity. Typical locations where the energy output may be lower include the ends 20. In a particular embodiment, heating uniformity is improved by locating the heating units 16 such that the portions of the heating volume V heated by adjacent heating units 16 overlap. In the embodiment shown, the heating units 16 are positioned in a same horizontal plane, and are longitudinally aligned in rows where the heating units 16 abut end 20 to end 20, with the rows being regularly spaced apart from one another. Other configurations are also possible.

Referring to FIGS. 1a-b and 3, in the embodiment shown, the mold support 14 includes at least one support member 22 configured to retain the mold 11 containing the composite material to be cured. Each support member 22 is located in the heating volume V such that the mold 11 supported thereby is also located in the heating volume V, sufficiently spaced apart from the heating units 16 such to be in a continuous region of the heating volume V and preferably a region where the radiant heat emitted by adjacent heating units 16 overlaps, as detailed above. Each support member 22 is also spaced apart from the heating units 16, such that a same planar section S (FIG. 1b) of the heating volume V can be defined as extending between the heating units 16 and the support members 22.

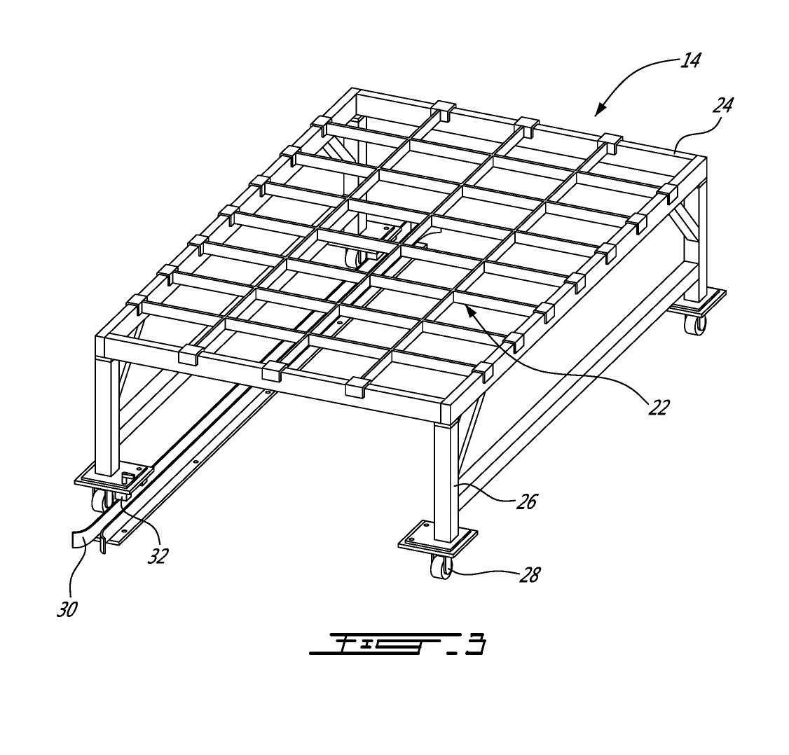

The mold 11, when supported by the mold support 14, is thus separated from the heating units 16 at least by the planar section S of the heating volume V, i.e. by a portion of the heating volumes bound by two parallel and spaced apart planes. In the embodiment shown, the planar section S extends horizontally. The planar section S extends at least across the mold 11, and in a particular embodiment extends beyond the mold 11. In an embodiment where the surface of the mold 11 facing the heating units 16 is planar, the planar section S of the heating volume V may be bound by this planar surface of the mold 11. In an embodiment where the surface of the mold 11 facing the heating units is not planar, the planar section S of the heating volume may be bound by a plane extending across and/or contacting the surface of the mold 11. Depending on the configuration of the mold support 14, the planar section S may alternately be bound by the support member(s) 22 with the mold 11 being spaced apart therefrom, i.e. located further away from the heating units 16, as shown in FIG. 3.

In a particular embodiment, the support members 22 have an adjustable position, such as to be able to vary their distance (e.g. the thickness of the planar section S of the heating volume V) with respect to the heating units 16.

Referring to FIG. 3, in the embodiment shown, the mold support 14 includes a frame 24 extending in a horizontal plane, and the support members 22 includes first and second plurality of spaced apart bars extending across the frame 24 perpendicularly to one another to form a grid-like pattern located within a plane and defining a planar support surface for supporting the mold 11. The bars 22 extend over the heating units 16, vertically spaced apart therefrom, and are sized and located such as to minimize obstruction of the radiant heat directed toward the mold 11 they are supporting. In another embodiment, the support members 22 may be shaped to detachably engage the mold 11 to prevent movement thereof (e.g. including fasteners, clamps, surfaces complementary to outer surfaces of the mold 11).

Alternately, the support members 22 may engage the mold 11 at another location than on the surface of the mold 11 facing the heating units 16, such that the mold 11 is closer to the heating units 16 than the support members 22 and such that the boundary of the planar section S of the heating volume V is defined by the surface of the mold 11 facing the heating units 16, as set forth above.

In the embodiment shown, the mold support 14 also includes four legs 26 extending downwardly from the frame 24 and each including a wheel 28 for contact with the ground, such as to facilitate engagement and disengagement of the mold support 14 from the heating unit support 12. A rail 30 is provided on the ground surface adjacent the heating unit support 12 to engage a complementary member 32 of the mold support 14 to guide the position of the mold support 14 in alignment with the heating units 12.

With the sides of the heating units 16 exposed, some heat losses may occur from the sides of the heating unit support 12, under and around the heating volume V. In a particular embodiment and referring to FIG. 1a, the heating unit support 12 and/or the mold support 14 includes reflective sides 34 enclosing a perimeter of the heating units 16, to help direct edge losses back to the heating volume V. Heating units 16 having a higher wattage may also be provided at the perimeter of the heating unit support 12 to compensate for side losses.

In addition and referring to FIG. 1b, in a particular embodiment, a layer of insulating material 36, for example provided in the form of a flexible blanket, is provided over the mold 11 and mold support 14 and around the heating unit support 12 to enclose the portion of the heating volume V used and help contain the heat to the component and mold 11 to reduce losses from the edges of the heating volume V.

In use, zones are defined in the heating volume V. Each zone is linked to at least one of the heating units 16, located to direct radiant heat thereon; in a particular embodiment, each zone is linked to a single respective heating unit 16, such that a zone is defined in alignment with each one of the heating units 16. Temperature sensors 38, for example thermocouples, are provided on the mold 11 or component to be cured; the component and mold 11 may extend across a single zone, but typically extends across multiple zones. As will be detailed further below, the device 10 also includes a controller receiving the temperature data from the temperature sensor(s) and individually controlling the power supply to the heating units 16 such as to maintain each zone at a desired temperature.

In a particular embodiment, the heating units 16 have a fixed position and orientation with respect to one another in the heating unit support 12, i.e. although the heating units 16 may be removable for example for maintenance purposes, they remain in the same position and orientation every time the device 10 is used. Accordingly, the heating volume V may be characterized and defined experimentally through a controlled heating of a test piece, for example a test plate containing at least one and preferably a plurality of temperature sensors in each zone, in successive tests performed at different distances from the heating units to determine if a component located at that distance can be accurately cured. Once the size of the heating volume V is defined, the device 10 may be certified for cure of various components within that volume. Accordingly, various mold supports 14 having support members 22 with different configurations to support different molds 11 for different components may be selectively engaged with the same heating unit support 12 and the components may be cured without having to change the configuration of the heating units 16.

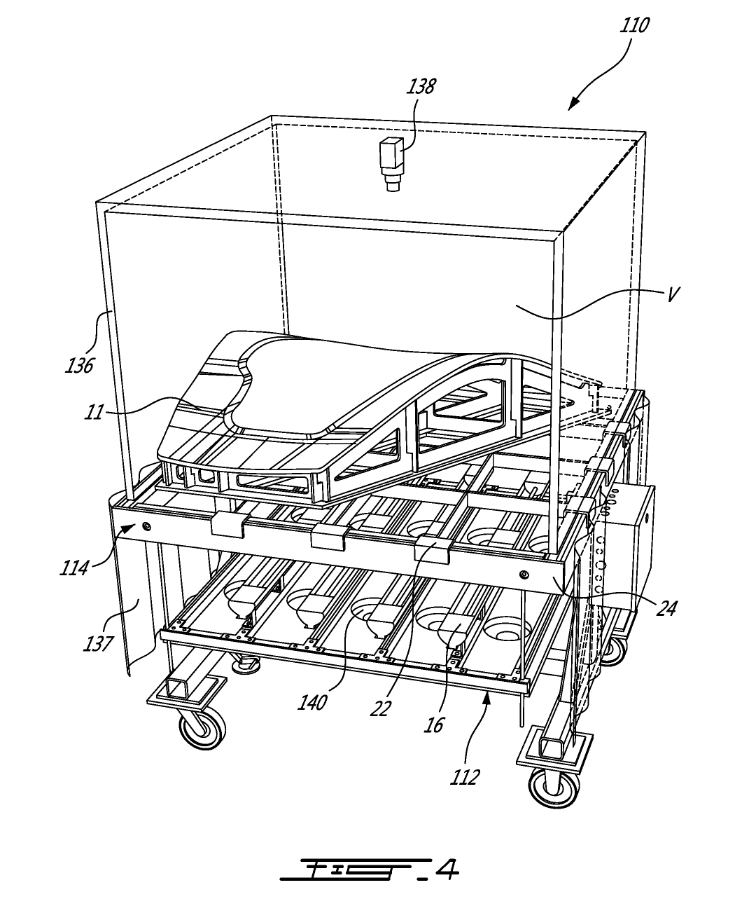

Referring to FIG. 4, a device 110 in accordance with another embodiment is shown. Similarly to the embodiment of FIG. 1, the heating unit support 112 includes the heating units 16 disposed in a horizontal plane and oriented upwardly, and the mold support 114 is engaged with the heating unit support 112 such that the support members 22 extend within the heating volume over the heating units. In this embodiment, the heating unit support 112 and the mold support 114 are attached to one another. Similar elements between the embodiments are identified by a same number and will not be further described herein.

In this embodiment, the heating volume V is enclosed in a casing 136, to minimize heat losses at its periphery. Although not shown, a selectively closable opening may be defined in the top and/or a side wall of the casing 136, to evacuate excess heat if required.

A thermal imaging camera 138 is provided on the top of the casing 136 and directed toward the heating volume V and part being cured. The thermal imaging camera 138 provides the temperature data to the controller in replacement of the temperature sensors 38 (e.g. thermocouples) placed on the mold 11 and/or the part.

The heating unit support 112, in addition to supporting the plurality of heating units 16 similarly to the previously described embodiment, also supports a plurality of cooling systems 140 in the form of fans. Each fan 140 is directed toward a respective one of the zones of the heating volume V. In a particular embodiment, each fan 140 is controlled by the controller based on the temperature reading of the zone. Accordingly, when the temperature in a zone needs to be lowered, in addition to reducing power to the associated heating unit 16, power to the associated fan 140 may be increased such as to cool the zone more rapidly.

It can be seen that in this embodiment, a layer of flexible insulating material 137 extends around the heating unit support 112 to minimize losses of heat from the sides.

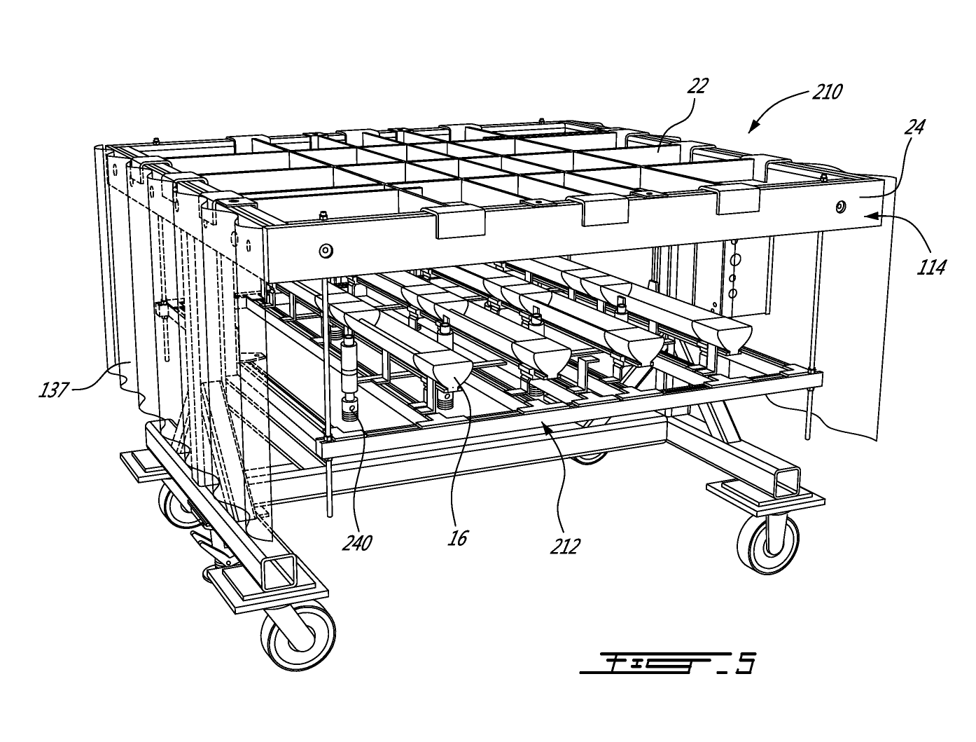

Referring to FIG. 5, a device 210 in accordance with another embodiment is shown. This embodiment is similar to that of FIG. 4, and similar elements are identified by a same number and will not be further described herein.

In this embodiment, the cooling systems 240 supported by the heating unit support 212 are air nozzles. Each nozzle 240 is directed toward a respective one of the zones of the heating volume. In a particular embodiment, each nozzle 240 is controlled by the controller based on the temperature reading of the zone. Accordingly, when the temperature in a zone needs to be lowered, in addition to reducing power to the associated heating unit 16, power to the associated nozzle 240 may be increased such as to cool the zone more rapidly. When compared to fans 140, the nozzles 240 may allow for more directed cooling.

In a particular embodiment, the devices of FIGS. 1-5 are used to cure a component made of prepreg composite material received on a surface of the mold 11 and with the mold 11 and prepreg being enclosed in an appropriate type of bag under vacuum. The prepreg is received on the side of the mold 11 which is not exposed to the radiant heat, such as to be heated by the heated mold 11 without being directly exposed to the radiant heat to avoid overheating.

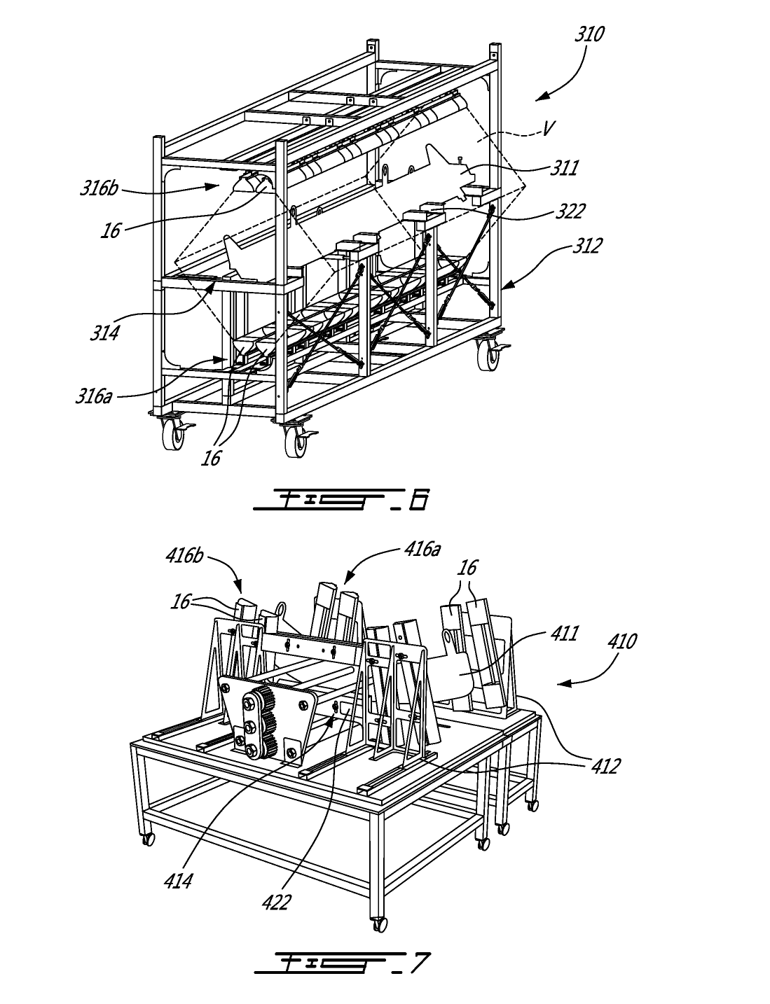

Referring to FIGS. 6-7, devices 310, 410 in accordance with other embodiments are shown. These devices 310, 410 are used to cure components formed by resin transfer molding (RTM), where fibers are placed in a closed mold and uncured resin is injected in fluid form through one or more openings of the mold before being cured to form the component. Accordingly, the component is enclosed between at least two complementary portions of the mold 311, 411. The heating unit support 312, 412 of each embodiment includes two arrays of heating units 16, with the mold support members 314, 414 being located therebetween.

In the embodiment of FIG. 6, a first horizontal array 316a of the heating units 16 is located under the mold support members 322 with the heating units 16 being oriented upwardly, while a second horizontal array 316b of the heating units 16 is located over the mold support members 322 with the heating units 16 being oriented downwardly. The heating volume V is defined between the two arrays 316a, 316b of heating units 16. Each array 316a, 316b includes two coplanar rows of the heating units 16 with the heating units in a same row abutting one another and the two rows also abutting one another.

The support members 322 are attached to the bottom portion of the mold 311 and the top portion of the mold is articulated with respect to the bottom portion. In this particular embodiment, the heating unit support 312 and the mold support 314 are connected in a single structure. Alternately, the mold support 312 may be removably engaged to the heating unit support 314.

As in the previous embodiments, each array 316a, 316b of the heating units 16 is spaced apart from the mold support members 322 by a planar section of the heating volume V.

In the embodiment of FIG. 7, a first vertical array 416a of the heating units 16 is located on one side of the mold support members 422 and a second vertical array 416b of the heating units 16 is located on the opposed side of the mold support members 422, with the heating units 16 of each array being oriented toward the heating units 16 of the other array, such that the heating volume is again defined between the two arrays 416a, 416b. Each array 416a, 416b includes a single row of the heating units 16 which are disposed with their longitudinal direction extending substantially vertically but at an angle with respect to the vertical direction, and with the heating units 16 of a same row extending at different angles from one another.

The support members 422 support the mold 411 such that the mold line extends vertically, and are attached to the portions of the mold 411 while allowing the portions to be separated to open the mold 411. In this particular embodiment, the heating unit support 412 and the mold support 414 are connected in a single structure. Alternately, the mold support 414 may be removably engaged to the heating unit support 412.

As in the previous embodiments, each array 416a, 416b of heating units 16 is spaced apart from the mold support members 422 by a planar section of the heating volume. In this embodiment, the planar section extends vertically.

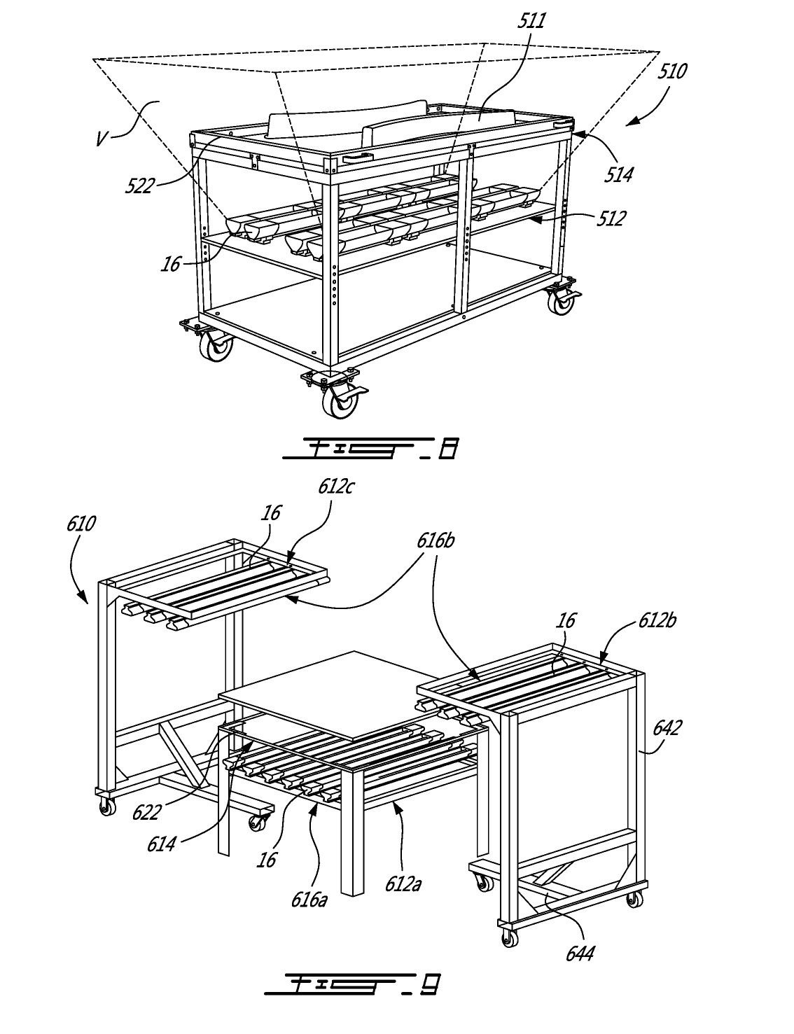

Referring to FIG. 8, another device 510 in accordance with a particular embodiment is shown. The device 510 is used to manufacture fiber preforms, where fibers are shaped and retained by a binder which is cured. The mold 511 in this case is a net shaped membrane made of flexible material and closing around the fibers to be formed, under vacuum pressure. The mold support members 522 include a frame on which the mold 511 may be attached. The mold support 514 has a cart configuration in which the heating unit support 512 is integrated, below the support members 522. Alternately, the mold support 514 may be removably engaged to the heating unit support 512.

The heating units 16 are provided in a horizontal array and oriented upwardly, the array including four coplanar rows of the heating units 16 with the heating units in a same row abutting one another and rows abutting one another two by two. A planar section of the heating volume V extends between the heating units and the support members.

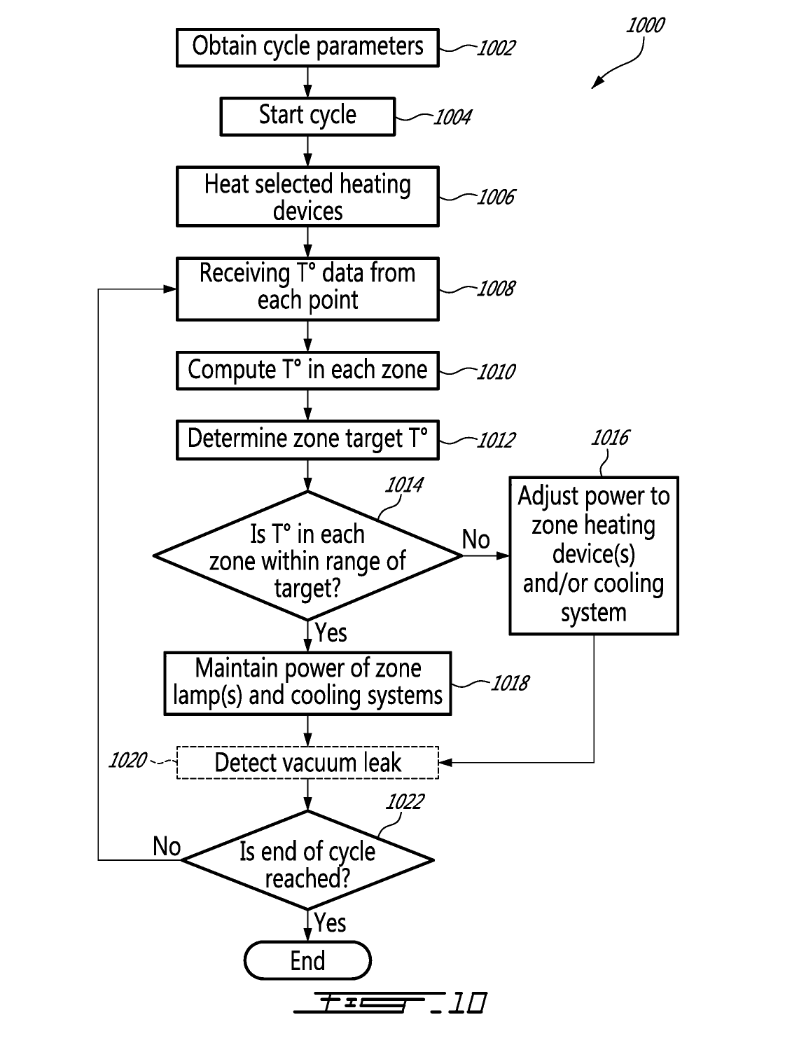

FIG. 9 shows another device 610 which may be used for any process requiring the mold and component to be heated from two opposite sides. The heating units 16 are supported by three heating unit support portions. A first horizontal array 616a of the heating units 16 is supported by a first heating unit support portion 612a located under the mold support members 622 of the mold support 614, with the heating units 16 being oriented upwardly. A second horizontal array 616b of the heating units 16 is located over the support members 612 with the heating units 16 being oriented downwardly, and is supported in two parts by complementary heating unit support portions 612b, 612c. The complementary heating unit support portions 612b, 612c each support their part of the second array 616b in a cantilevered manner from a side structure 642 which extends upwardly from a wheeled base 544. In use, the side structures 642 are located in proximity of the mold support 514 and the wheeled base 644 extends under the first array 616a of the heating units 16. The heating volume is defined between the two arrays 616a, 616b of heating units 16. Each array 616a, 616b includes multiple spaced apart rows of the heating units 16 with the heating units 16 in a same row abutting one another.

As in the previous embodiments, each array 616a, 616b of heating units is spaced apart from the mold support members 622 by a planar section of the heating volume.

In each embodiment, the mold support 22, 322, 422, 522, 622 shown may be replaced by a different mold support, whether similar to that of another one of the embodiments shown or having a different configuration, and be cured by the same configuration and orientation of the heating units 16, provided the mold 11, 311, 411, 511 and component supported thereon are located in the corresponding heating volume V. Accordingly, in a particular embodiment, the device 10, 110, 210, 310, 410, 510, 610 may be used interchangeably to cure a variety of different components without reconfiguration.

Although the horizontal arrays have been shown with regularly spaced apart heating units 16, in an alternate embodiment the spacing between the heating units 16 may be irregular. Each cure cycle performed with the device 10, 110, 210, 310, 410, 510, 610 may be performed using all or only some of the heating units 16 and zones of the heating volume V, depending on the volume occupied by the component being cured—i.e. in a particular embodiment only the zones occupied by the mold being heated are used.

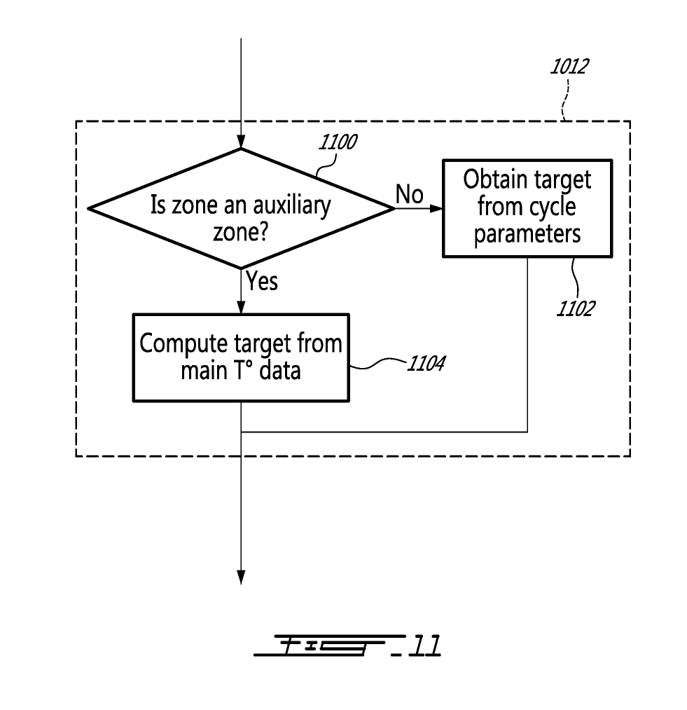

In a particular embodiment, and with reference to FIG. 10, the component is cured according to the following method 1000.

The heating cycle parameters are obtained in step 1002, from a user input and/or from a database. In a particular embodiment, the cycle parameters include the heating profile to be applied (e.g. ramp rates, temperature and time for each dwell, zones to be heated, together defining a cure “recipe” to be followed), and the point(s) (e.g. thermocouple(s)) where the temperature reading is used to control each one of the zones being heated. Multiple points may be used to control a single zone. Each zone is controlled by at least one point. Multiple zones may be controlled using a common point. In a particular embodiment, the zones are predefined and always associated with the same heating unit(s); in another embodiment, the cycle parameters also include the identification of the heating units and corresponding zones. The user may enter each parameter manually, or retrieve them from a database. The user may also save a particular set of parameters to the database for re-use.

The heating cycle is then started at step 1004. The heating units of the zones used are powered at step 1006, and the mold supporting the component is heated through the radiant energy emitted thereby.

All through the cycle, the temperature data for each one of a plurality of points is received, as shown in 1008. Each reading is indicative of the temperature of the component; the reading may be taken for example directly on the component, or on the mold supporting the component. Accordingly, temperature data for a plurality of points indicative of a temperature of the component at or around the location of the points is received and processed. In a particular embodiment, the plurality of points is limited to the points indicated as being used to control each of the zones in the cycle parameters. In another embodiment, the plurality of points includes additional points where the temperature is measured and not used for control, e.g. to be displayed for monitoring purposes.

The temperature in at least one zone, and in a particular embodiment in each zone, is computed from the received temperature data in step 1010, using the temperature data from the points identified as being used for control in the cycle parameters for that zone. The temperature of each zone is computed from the temperature of at least one point; however, as mentioned above, a single point may be used to control more than one zone, depending on the locations of the points and on the degree of control desired. For example, the temperature at a first point located in a first zone may be used to control the first zone, the temperature at a second point located in a second zone used to control the second zone, and the temperature at the first and second points used together to control a third zone located between the first and second zones.

If the zone is controlled by the temperature at a single point, the temperature of the zone is taken at the temperature at this point. If the zone is controlled by the temperature at multiple points, the temperature of the zone is computed from these multiple readings, for example through an average thereof. In a particular embodiment, the influence of the temperature at each point to control a zone is weighted to take its placement into consideration. If the temperature is measured using a surface reading, for example with an infrared imaging system, the temperature of the zone is determined through appropriate processing of the image received for that zone to determine the temperature at the desired number of points in the zone.

The target temperature for at least one zone, and in a particular embodiment for each zone, is then determined in step 1012. When a single component is being cured, the target temperature is obtained from the cycle parameters, as the theoretical temperature that should have been reached at the particular time the analysis is being performed based on the requested heating profile.

In a particular embodiment, first and second components are cured simultaneously, with the first component (e.g. auxiliary component) being cured such as to representative of the cure state of the second component (e.g. main component) once the cure is performed, for example to be used in destructive testing to obtain results indicative of the properties of the second component. Typically, with curing in an autoclave, the first and second components are cured in the same autoclave or oven with each component being put under the same vacuum pressure, for example by providing fluid communication between the two mold cavities through an umbilical connection. However, as temperatures may vary within the enclosure of an autoclave or oven, the cure of the two components may be different from one another.

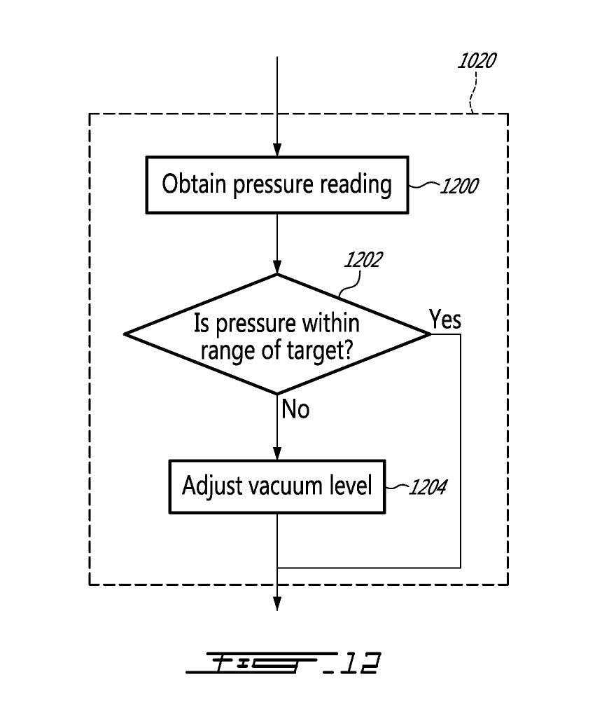

In the present embodiment, and with reference to FIG. 11, determination of the target temperature of a zone includes the determination of whether a zone is an auxiliary zone in step 1100, i.e. a zone containing the first component intended to represent the cure of the second component. If the zone contains the second component, the target temperature is obtained from the cycle parameters in step 1102, as detailed above.

If the zone contains the first (representative) component, the target temperature of the zone is obtained from the temperature data of the second component as shown in step 1104. For example, the target temperature for the first component may be defined as an average of the temperature of all the points associated with the second component at the particular time the analysis is being performed. The temperatures may be weighted based on their location. Alternately, the target temperature of the first component may be defined as the temperature at a single point or as an average of the temperature of only part of the points, selected to represent critical location(s) of the second component. Accordingly, more than one representative (e.g. auxiliary) component may be cured together with the second component with each representative component being representative of the cure of a particular section of the second component.

Also, it is understood that the method may be used to cure only the first component while the second component is being cured using another method and/or system, and using radiant heating or any other type of appropriate heating.

In order for the cure of the first component to be representative of that of the second component, the two mold cavities are preferably linked, for example through an umbilical connection, to ensure that a same vacuum pressure is applied to both.

Referring back to FIG. 10, once the target temperature has been obtained for each zone in step 1012, the temperature of at least one zone, and in a particular embodiment of each zone (each auxiliary zone, and each zone containing the second component if the second component is being cured using the same system), is compared with a predetermined range around its target in step 1014. In a particular embodiment, the predetermined range is ±0, such that the comparison is performed directly with the target.

If the zone temperature is outside of the range, the heating unit(s) assigned to the zone, and/or the cooling systems, if such are provided, are adjusted in step 1016. In the particular embodiment shown, the heating unit(s) and/or the cooling systems are adjusted by adjusting a power input thereof. Other adjustments are also possible.

Accordingly, in the embodiment shown, if the temperature of the zone is higher than the predetermined range, the power input to the heating unit(s) is lowered and/or the power input to the cooling system(s) is increased; if the temperature of the zone is lower than the predetermined range, the power input to the heating unit(s) is increased and/or the power input to the cooling system(s) is lowered.

In a particular embodiment where the predetermined range is ±0, the heating units are thus adjusted each time the temperature differs from the target. Accordingly, in a particular embodiment, the power input of each heating unit may be modulated at a frequency of 1000 times per second or more.

If the zone temperature is within the range, the power input to the heating unit(s) assigned to the zone, and/or the cooling systems, if such are provided, is maintained, as shown in step 1018.

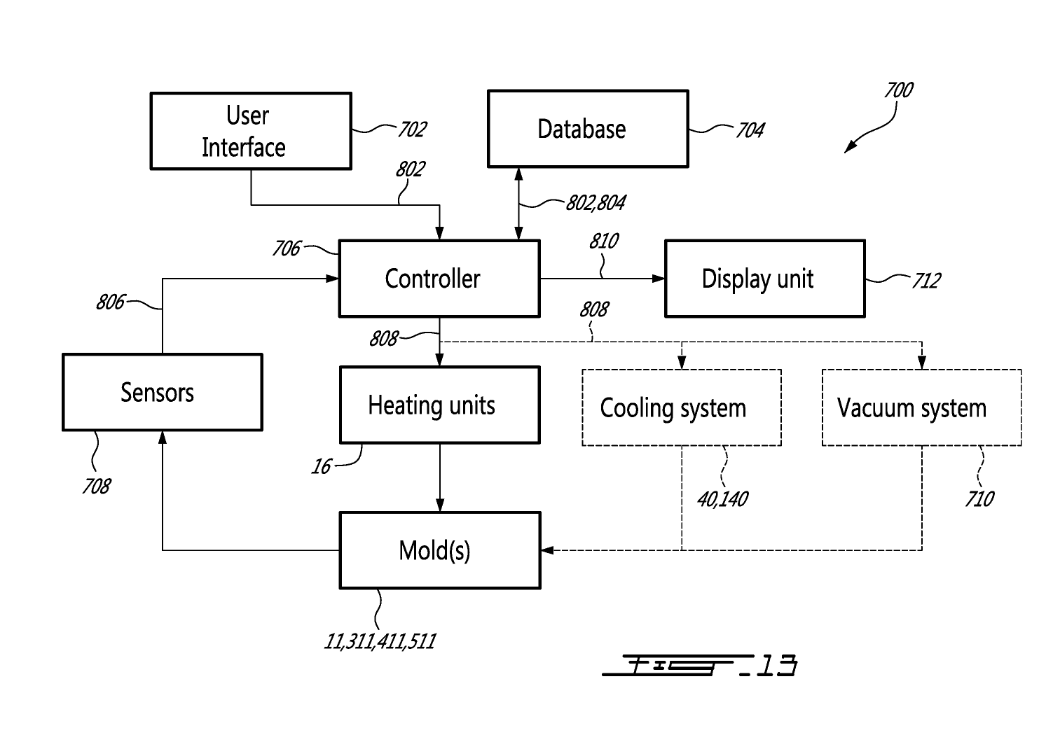

Optionally, the same system may be used to detect vacuum leaks when the cure is performed under vacuum, as shown in 1020. Referring to FIG. 12, a pressure reading is obtained in step 1200, and the pressure reading is compared to a predetermined target range in step 1202, for example obtained from the cycle parameters. If the pressure reading is outside the range, the vacuum level is adjusted in step 1204. Although not shown, if the vacuum level cannot be maintained, an alarm (audio/and or visual) may be generated. Advantageously, since the heat is directed to the mold and contained, the environment of the curing component remains accessible to a worker to correct any leaks if such are able to be detected through an inspection as the component is being cured.

Referring back to FIG. 10, an evaluation is then made in step 1022 to determine whether the end of the requested heating cycle has been reached. If not, the steps of the method are repeated from step 1008 described above, such that the temperature in each zone is individually and continuously monitored and controlled throughout the duration of the heating cycle.

In a particular embodiment, the predetermined range around the target, which may be ±0 or have a different value, is selected such that the component being cured undergoes each ramp up in temperature with a particular ramp rate or ramp rate range, for example a minimum ramp rate of 1° F./min (0.6° C./min) and/or a maximum ramp rate of 5° F./min (2.7° C./min), and/or with a particular acceptable variation during each dwell temperature, for example at most ±10° F. (±5.6° C.). It is understood that other ramp rates and/or acceptable dwell temperature variations may be used. The verification of these conditions may be performed during the cure or after, using temperature at the points used to control the zones and/or at other points on the component.

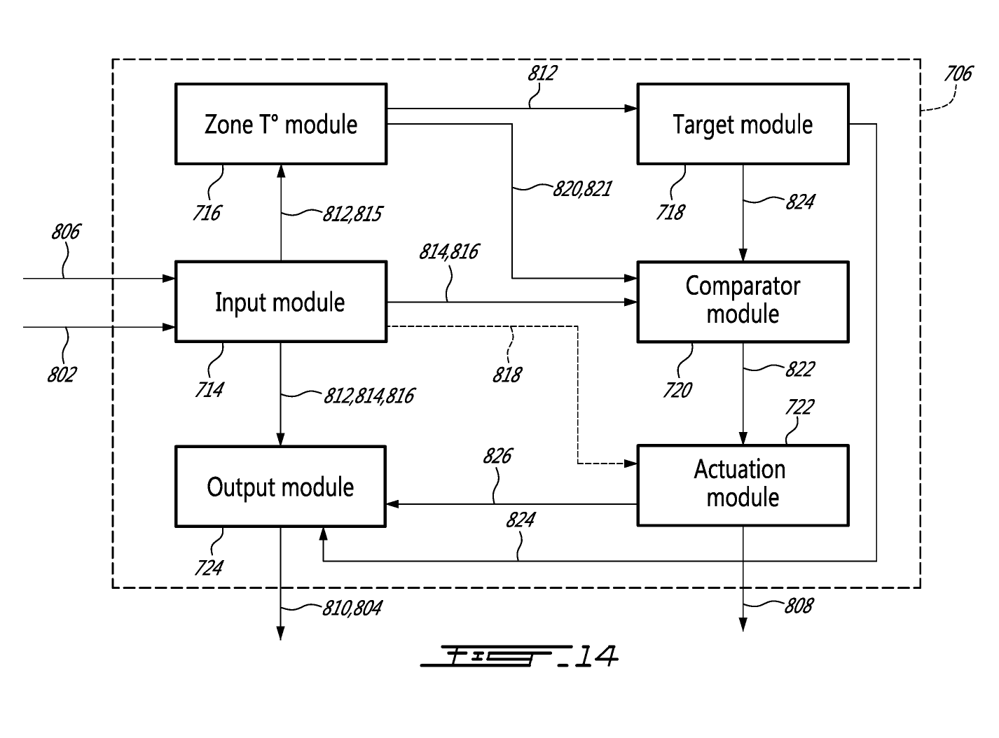

Referring to FIG. 13, a system 700 for controlling the curing of one or more components is generally shown. The system 700 includes a user interface 702, e.g. keyboard, touch screen, mouse, etc. configured to receive the cycle parameters from the user, and a database 704 from which the cycle parameters may be obtained and in which they may be saved. The database 704 may also receive history data 804 from the curing process, such as to be able to save for example the temperature data obtained as the cure is being performed.

The system 700 includes a controller or control system 706 receiving the cycle parameters 802 from the user interface 702 and/or database 704, and receiving the data 806 provided by the sensors 708, which may include the sensors 38 described above such as thermocouples, thermal imaging system 138, as well as pressure sensor(s). The controller 706 sends actuation signals 808 to the heating units 16, the cooling systems 40, 140 if such are provided, and optionally, the vacuum system 710. The system 700 also includes a display unit 712 (e.g. screen) receiving a display signal 710 from the controller 706 containing the information to be displayed. In a particular embodiment, the information displayed includes the temperature read by each sensor during the cycle and the corresponding target temperature, the pressure read and/or an indication of whether adequate vacuum was maintained or not during the cycle, and the power input provided to each of the heating units. In a particular embodiment, the displayed temperatures readings include the data of the temperature sensors used to control each zone and the data from additional temperature sensors used only for monitoring purposes. The information may be displayed in any appropriate form, including graph and/or numerical form.

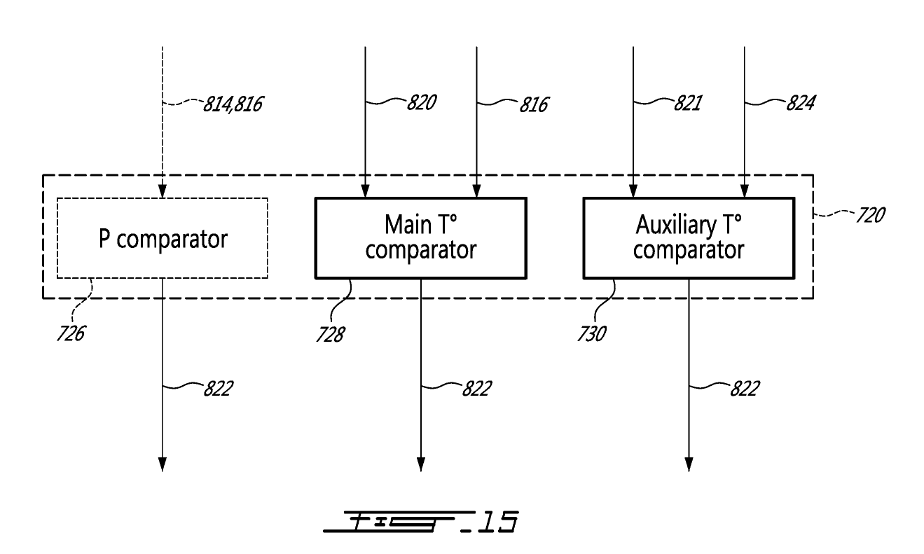

Referring to FIG. 14, the controller or control system 706 according to a particular embodiment is shown in more detail. The controller 706 generally includes an input module 714, a zone temperature module 716, a target module 718, a comparator module 720, an actuation module 722, and an output module 724.

The input module 714 receives the sensor data 806, including temperature data 812 and optionally pressure data 814, and sends the temperature data 812 to the zone temperature module 716, the pressure data 814, if applicable, to the comparator module 720, and both to the output module 724. The input module 714 receives the cycle parameters 802, and accordingly sends control data 815 indicative of the selection of the points controlling at least one zone, and in a particular embodiment each zone, to the zone temperature module 716, and target data 816 for the temperature of the zones of the main component and optionally for the pressure to the comparator module 720. In an embodiment where the heating units 16 and/or cooling systems 40, 140 are not always associated with the same zones of the heating volume, the input module 714 also sends data 818 to the actuation module 722 indicative of which heating units/cooling systems are associated with each zone, based on the cycle parameters. Alternately, the required information in each of the modules may be received directly by that module, and the input module 714 may be omitted.

The zone temperature module 716 receives the temperature data 812 and, for at least one and in particular each of the zones which are being heated, computes the temperature of the zone from the temperature data of the point(s) associated therewith, as detailed above. In a case where first and second components are being cured by the same system with the cure of the first component being representative of the cure of the second component, the zone temperature module thus computes the zone temperature for at least one and in particular each zone occupied by the mold of the first component and for at least one and in particular each zone occupied by the mold of the second component.

The target module 718 is used when a representative (e.g. auxiliary) component is being cured. The target module 718 receives the temperature data 812 for the points associated with the second component, for example from the zone temperature module 716, and computes the target temperature for the first (representative) component from this temperature data, as detailed above.

The comparator module 720 receives the zone temperature 820, 821 for at least one and in particular each zone from the zone temperature module 716, compares the temperature in the zone with the predetermined range around its target, and sends a comparison signal 822 indicative of the result of this comparison. Optionally, the comparator module 720 also compares the pressure in the mold with its target. Referring to FIG. 15, in a particular embodiment, the comparator module includes a pressure comparator 726 receiving the pressure data 814 and target 816 from the input module 714 and sending a comparison signal 822 indicative of a result of a comparison therebetween; a main temperature comparator 728 receiving the zone temperature 820 of the zones of the second (e.g. main) component from the zone temperature module 716 and the target data 816 for the zones of the second component from the input module 714, and sending a comparison signal 822 indicative of a result of a comparison therebetween; and an auxiliary temperature comparator 730 receiving the zone temperature 821 of the zones of the first (e.g. auxiliary) component from the zone temperature module 716 and the target 824 for the zones of the first component from the target module 718, and sending a comparison signal 822 indicative of a result of a comparison therebetween. In another embodiment, the pressure comparator 726 is omitted, and the vacuum is monitored by a different system.

In a particular embodiment, the target temperature and range therearound is the same for all the zones of a same component. More than one component may be simultaneously cured based on a same or on different heat cycles characterized by their respective cycle parameters. The target temperature and/or range therearound may thus be different for zones of different components.

Referring back to FIG. 14, the actuation module 722 receives the comparison signal(s) 822 from the comparator module 720 and sends an actuation signal 808 to the heating units 16 to adjust the power supply to the heating unit(s) 16 associated with at least one zone used, and in a particular embodiment with each zone used, based on the comparison signal, e.g. to reduce power when the comparison signal indicates that the temperature in the zone is higher than the predetermined range around the target and to increase power when the comparison signal indicates that the temperature of the zone is lower than the predetermined range around the target. In an embodiment when cooling systems 40, 140 are used in association with the zones, the actuation module 722 also sends an actuation signal 822 to the cooling systems 40, 140 to adjust the cooling system(s) 40, 140 (e.g. through adjustment of the power supply) associated with each zone used based on the comparison signal, e.g. to increase power when the comparison signal indicates that the temperature in the zone is higher than the predetermined range around the target and to reduce power when the comparison signal indicates that the temperature of the zone is lower than the predetermined range around the target. When the pressure is being monitored by the system, the actuation module 822 also sends an actuation signal to the vacuum system 710 based on the associated comparison signal.

The output module 724 receives the information to be displayed and/or saved in the database from each relevant module, for example the temperature data 812 for each point (including the points used for control and optionally additional points), the pressure data 814, the second component target data and the pressure target data 816 from the input module 714, the first target data 824 from the target module 718, and actuation data 826 indicative of the actuation signal 808 (e.g. % of power requested from the heating units) from the actuation module 722, and accordingly sends a display signal 810 to the display unit 712 and/or history data 804 to be saved to the database 704. Alternately, the display signal 810 and/or history data 804 associated with each of the modules may be generated directly by that module, and the output module 724 may be omitted.

It is understood that the control system 700 may include more or less modules than the embodiment shown. For example, a same module may be configured to perform more than one function.

In a particular embodiment, the device 10, 110, 210, 310, 410, 510, 610 allows for heating and curing of composite materials out of oven/autoclave, which may allow for access to the part during cure, for example to apply pressure to help conform the part to the mold once the part has been softened by the heat or to correct a vacuum leak, without stopping the curing process. The device may offer similar versatility than an oven or autoclave with respect to the variation of tools and part which may be heated therewith, by having the heating units in a fixed position to define a heating volume which may be characterized and/or certified to be used with any part geometry received in the heating volume, while offering more accurate control and/or reproducibility of cure conditions through the individual control of each zone of the heating volume and/or lower power requirements from the use of radiant energy instead of convective heating.

The device 10, 110, 210, 310, 410, 510, 610 may also allow for simultaneous curing of two or more components at the same time using the same device and control system but following different cure cycles with different ramp rates and/or dwell temperatures and times.

As detailed above, the device 10, 110, 210, 310, 410, 510, 610 may also allow for a first component intended to represent a cure of a second component to be cured in conditions following more closely those of the cure of the second component, by being controlled by the temperature variations in the second component.

While the methods and systems described herein have been described and shown with reference to particular steps performed in a particular order, it will be understood that these steps may be combined, subdivided or reordered to form an equivalent method without departing from the teachings of the present invention. Accordingly, the order and grouping of the steps is not a limitation of the present invention.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. A device for curing a composite material, the device comprising:
a heating unit support supporting a plurality of heating units each having a radiant heat source directed toward a corresponding portion of a heating volume, at least some of the heating units being controllable independently of one another, the heating volume being formed by the combination of radiations emitted by the heating units when the heating units are powered; and
a mold support configured to retain a mold containing the composite material to be cured, the mold being separated from the heating units at least by a planar section of the heating volume when the mold is retained by the mold support.

2. The device as defined in claim 1, wherein all the heating units are controllable independently of one another.

3. The device as defined in claim 1, wherein the mold support includes at least one support member spaced apart from the heating units and configured to retain the mold, each support member being located in the heating volume and being separated from the heating units by the planar section of the heating volume.

4. The device as defined in claim 1, wherein the planar section of the heating volume extends across a surface equal to a surface of the mold exposed to the heating volume.

5. The device as defined in claim 4, wherein the surface of the mold is non-planar.

6. The device as defined in claim 1, wherein the planar section of the heating volume extends beyond the mold.

7. The device as defined in claim 1, further comprising a controller connected to the heating units to control each of the heating units to form a continuous distribution of the radiations on at least part of the mold.

8. The device as defined in claim 7, further comprising at least one temperature sensor for collecting data indicative of a temperature of the composite material, the controller being connected to the at least one temperature sensor to control the heating units based on data from the at least one temperature sensor.

9. The device as defined in claim 1, further comprising a plurality of cooling systems supported by the heating unit support and oriented toward the heating volume such as to direct a flow of air in the heating volume when powered.

10. The device as defined in claim 8, further comprising a plurality of cooling systems supported by the heating unit support and oriented toward the heating volume such as to direct a flow of air in the heating volume when powered, the controller being connected to the cooling systems to control the cooling systems based on the data from the at least one temperature sensor.

11-13. (canceled)

14. The device as defined in claim 1, wherein the heating units are positioned in a same plane.

15-17. (canceled)

18. The device as defined in claim 1, wherein each of the heating units is a lamp, the radiant heat source extending longitudinally and configured to emit radiation having a wavelength at least within the infrared range.

19. The device as defined in claim 1, wherein the mold support is a first mold support and is removably engaged to the heating support and wherein the mold is a first mold, the system further comprising a second mold support configured to retain a second mold different from the first mold, the system being selectively configurable between a first configuration where the first mold support is engaged to the heating support, and a second configuration where the first mold support is removed and the second mold support is engaged to the heating support and located in the heating volume spaced apart from the heating units, a configuration and orientation of the heating units remaining constant between the first and second configurations.

20. The device as defined in claim 1, further comprising a layer of insulating material enclosing the heating units and the heating volume together.

21. (canceled)

22. A method of curing a first component made of composite material using radiant energy, the method comprising:
heating a first mold supporting the first component with radiant energy emitted by heating units as a second component is being cured, the first component and mold being located in a heating volume divided into a plurality of zones each associated with at least one of the heating units;
receiving second component temperature data indicative of a temperature of the second component;
computing a target temperature from the second component temperature data; and
for at least one of the zones occupied by the first mold:
receiving first component temperature data from at least one point indicative of a temperature of the first component in the zone,
computing a temperature in the zone from the first component temperature data associated therewith,
comparing the temperature of the zone with the target temperature computed from the second component temperature data, and
adjusting the at least one of the heating units associated with the zone when the temperature thereof is outside of a predetermined range around the target temperature computed from the second component temperature data.

23. The method as defined in claim 22, wherein the method is performed for each one of the zones occupied by the first mold.

24. The method as defined in claim 22, wherein the predetermined range is ±0, such that the at least one of the heating units associated with the zone is adjusted every time the temperature thereof differs from the target temperature.

25. The method as defined in claim 22, further comprising, for the at least one of the zones occupied by the first mold, adjusting a cooling system producing a cooling air flow on the zone when the temperature of the zone is outside of the predetermined range.

26. The method as defined in claim 22, wherein the first component temperature data for the at least one point is received from a respective one of a plurality of temperature sensors engaged to the first mold or the first component.

27. The method as defined in claim 22, further comprising:
heating a second mold supporting the second component with the radiant energy emitted by the heating units, the second component and mold being located in the heating volume;
obtaining a second target temperature from a predetermined heating profile; and
for at least one of the zones occupied by the second mold:
receiving the second component temperature data from at least one point indicative of a temperature of the second component in the zone,
computing a temperature in the zone from the second component temperature data associated therewith,
comparing the temperature of the zone with the second target temperature, and
adjusting the at least one of the heating units associated with the zone when the temperature thereof is outside of a predetermined range around the second target temperature.

28. The method as defined in claim 27, wherein the method is performed for each one of the zones occupied by the second mold.

29. The method as defined in claim 27, wherein the predetermined range around the second target temperature is ±0, such that the at least one of the heating units associated with the zone occupied by the second mold is adjusted every time the temperature thereof differs from the second target temperature.

30. A control system for controlling curing of a first component supported by a first mold and located in a heating volume divided into a plurality of zones each associated with at least one radiant heating unit, the first component being cured through radiant heating of the first mold with the at least one radiant heating unit associated with at least one of the zones occupied by the first mold, the system comprising:
a zone temperature module configured to, for the at least one of the zones occupied by the first mold, receive first component temperature data from at least one point indicative of a temperature of the first component in the zone, and compute a temperature in the zone from the first component temperature data;
a target module configured to receive second component temperature data indicative of a temperature of the second component as the second component is being cured and to compute a target temperature from the second component temperature data;
a comparator module configured to receive and compare the temperature in the at least one of the zones occupied by the first mold with a predetermined range around the target temperature computed from the second component temperature data, and send a comparison signal indicating a result of the comparison; and
an actuation module configured to receive the comparison signal and adjust the at least one heating unit associated with the at least one of the zones occupied by the first mold and having the temperature thereof outside of the predetermined range.

31-35. (canceled)
